(19) United States
(12) Patent Application Publication
(10) Pub. No.: US 2006/0050716 A1
(43) Pub. Date: Mar. 9, 2006

(54) Generic flow control state machine for multiple virtual channel types in the advanced switching (AS) architecture

(75) Inventor: Aric Griggs, Chandler, AZ (US)

Correspondence Address: FISH & RICHARDSON, PC, P.O. BOX 1022, MINNEAPOLIS, MN, 55440-1022, US

(73) Assignee: Intel Corporation

(21) Appl. No.: 10/934,644

(22) Filed: Sep. 3, 2004

(51) Int. Cl. H04L 12/56; H04L 12/28

(52) U.S. Cl. 370/397

(57) ABSTRACT

An Advanced Switching (AS) device may include a generic state machine to handle flow control (FC) credit initialization and updates for all three types of virtual channels (VCs), i.e., bypass VCs (BVCs), ordered VCs (OVCs), and multicast VCs (MVCs), while handling each type of VC according to its unique requirements. The state machine may transition between states in response to signals from VC logic and disable signals a packet arbiter. The generic state machine may be instantiated for all VCs supported by the AS device.

### BACKGROUND

PCI (Peripheral Component Interconnect) Express is a serialized I/O interconnect standard developed to meet the increasing bandwidth needs of the next generation of computer systems. PCI Express was designed to be fully compatible with the widely used PCI local bus standard. PCI is beginning to hit the limits of its capabilities, and while extensions to the PCI standard have been developed to support higher bandwidths and faster clock speeds, these extensions may be insufficient to meet the rapidly increasing bandwidth demands of PCs in the near future. With its high-speed and scalable serial architecture, PCI Express may be an attractive option for use with or as a possible replacement for PCI in computer systems. The PCI Express architecture is described in the PCI Express Base Architecture Specification, Revision 1.0a (Initial release Apr. 15, 2003), which is available through the PCI-SIG (PCI-Special Interest Group) (http://www.pcisig.com)].

Advanced Switching (AS) is an extension to the PCI Express architecture. AS utilizes a packet-based transaction layer protocol that operates over the PCI Express physical and data link layers. The AS architecture provides a number of features common to multi-host, peer-to-peer communication devices such as blade servers, clusters, storage arrays, telecom routers, and switches. These features include support for flexible topologies, packet routing, congestion management (e.g., credit-based flow control), fabric redundancy, and fail-over mechanisms. The AS architecture is described in the Advanced Switching Core Architecture Specification, Revision 1.0 (the “AS Specification”) (December 2003), which is available through the ASI-SIG (Advanced Switching Interconnect-SIG) (http//:www.asi-sig.org).

### BRIEF DESCRIPTION OF THE DRAWINGS

FIG. 1 is a block diagram of a switched fabric network according to an embodiment.

FIG. 2 shows the protocol stacks for the PCI Express and Advanced Switching (AS) architectures.

FIG. 3 illustrates an AS transaction layer packet (TLP) format.

FIG. 4 illustrates an AS route header format.

FIG. 5 is a block diagram of a local AS device including FC state machines for supported virtual channels (VCs).

FIG. 6 is a block diagram of an FC state machine.

FIG. 7 is a state transition diagram for the FC state machine.

### DETAILED DESCRIPTION

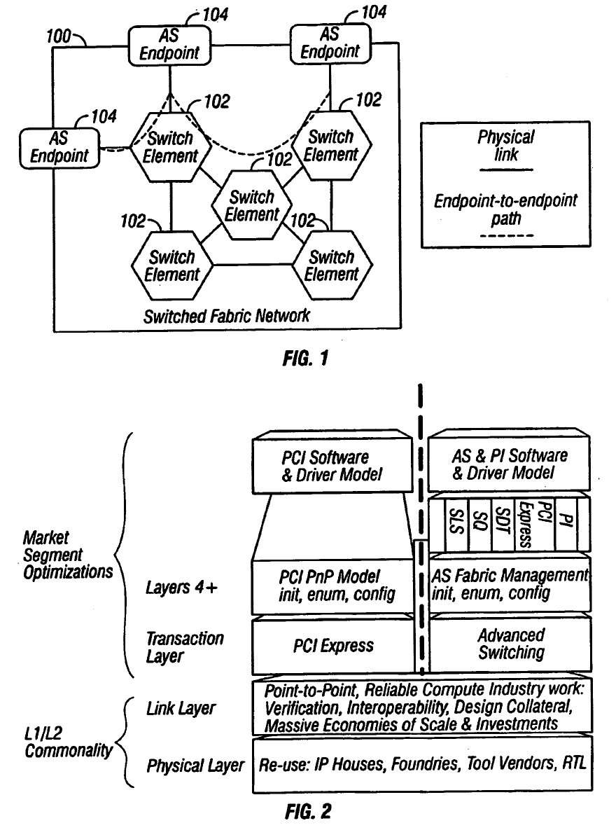

FIG. 1 shows a switched fabric network 100 according to an embodiment. The network may include switch elements 102 and end nodes 104. The switch elements 102 constitute internal nodes of the network 100 and provide interconnects with other switch elements 102 and end nodes 104. The end nodes 102 reside on the edge of the switch fabric and represent data ingress and egress points for the switch fabric. The end nodes may encapsulate and/or translate packets entering and exiting the switch fabric and may be viewed as “bridges” between the switch fabric and other interfaces.

The network 100 may have an Advanced Switching (AS) architecture. AS utilizes a packet-based transaction layer protocol that operates over the PCI Express physical and data link layers 202, 204, as shown in FIG. 2.

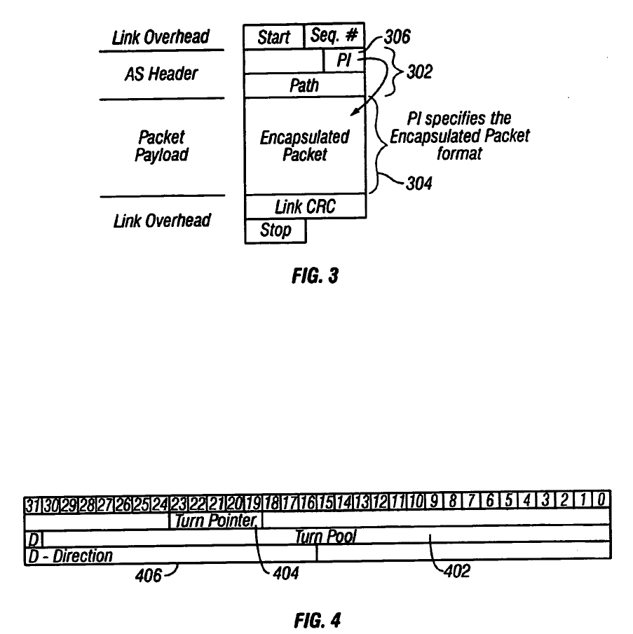

AS uses a path-defined routing methodology in which the source of a packet provides all information required by a switch (or switches) to route the packet to the desired destination. FIG. 3 shows an AS transaction layer packet (TLP) format 300. The packet includes a route header 302 and an encapsulated packet payload 304. The AS route header 302 contains the information necessary to route the packet through an AS fabric (i.e., “the path”), and a field that specifies the Protocol Interface (PI) of the encapsulated packet. AS switches use only the information contained in the route header 302 to route packets and do not care about the contents of the encapsulated packet 304.

A path may be defined by the turn pool 402, turn pointer 404, and direction flag 406 in the route header, as shown in FIG. 4. A packet's turn pointer indicates the position of the switch's “turn value” within the turn pool. When a packet is received, the switch may extract the packet's turn value using the turn pointer, the direction flag, and the switch's turn value bit width. The extracted turn value for the switch may then used to calculate the egress port.

The PI field 306 in the AS route header 302 (FIG. 3) specifies the format of the encapsulated packet. The PI field is inserted by the end node that originates the AS packet and is used by the end node that terminates the packet to correctly interpret the packet contents. The separation of routing information from the remainder of the packet enables an AS fabric to tunnel packets of any protocol.

PIs represent fabric management and application-level interfaces to the switched fabric network 100. Table 1 provides a list of PIs currently supported by the AS Specification.

TABLE 1
AS protocol encapsulation interfaces

| P1 number | Protocol Encapsulation Identity (PEI) |
|---|---|
| 0 | Fabric Discovery |
| 1 | Multicasting |
| 2 | Congestion Management |
| 3 | segmentation and Reassembly |
| 4 | Node Configuration Management |
| S | Fabric Event Notification |
| 6 | Reserved |
| 7 | Reserved |
| 8 | PCI-Express |
| 9-223 | ASI-SIG defined PEIs |
| 224-254 | Vendor-defined PEIs |
| 255 | Invalid |

PIs 0-7 are reserved for various fabric management tasks, and PIs 8-254 are application-level interfaces. As shown in Table 1, PI8 is used to tunnel or encapsulate native PCI Express. Other PIs may be used to tunnel various other protocols, e.g., Ethernet, Fibre Channel, ATM (Asynchronous Transfer Mode), InfiniBand®, and SLS (Simple Load Store). An advantage of an AS switch fabric is that a mixture of protocols may be simultaneously tunneled through a single, universal switch fabric making it a powerful and desirable feature for next generation modular applications such as media gateways, broadband access routers, and blade servers.

The AS architecture supports the implementation of an AS Configuration Space in each AS device in the network. The AS Configuration Space is a storage area that includes fields to specify device characteristics as well as fields used to control the AS device. The information is presented in the form of capability structures and other storage structures, such as tables and a set of registers. Table 2 provides a set of capability structures (“AS native capability structures”) that are defined by the AS Specification.

TABLE 2
AS Native Capability Structures

| | End | Switch |
|---|---|---|
| AS Native Capability Structure | nodes | Elements |
| Baseline Device | R | R |
| Spanning Tree | R | R |
| Spanning Tree Election | O | N/A |
| Switch Spanning Tree | N/A | R |
| Device PI | O | O |
| Scratchpad | R | R |
| Doorbell | O | O |
| Multicast Routing Table | N/A | O |
| Semaphore | R | R |
| AS Event | R | R |
| AS Event Spooling | O | N/A |
| AS Common Resource | O | N/A |
| Power Management | O | N/A |
| Virtual Channels | R w/OE | R w/OE |
| Configuration Space Permission | R | R |
| Endpoint Injection Rate Limit | O | N/A |
| Status Based Flow Control | O | O |
| Minimum Bandwidth Scheduler | N/A | O |
| Drop Packet | O | O |
| Statistics Counters | O | O |
| SAR | O | N/A |
| Integrated Devices | O | N/A |

Legend:
O = Optional normative
R = Required
R w/OE = Required with optional normative elements
N/A = Not applicable

The information stored in the AS native capability structures may be accessed through PI-4 packets, which are used for device management.

In one implementation of a switched fabric network, the AS devices on the network may be restricted to read-only access of another AS device's AS native capability structures, with the exception of one or more AS end nodes which have been elected as fabric managers.

A fabric manager election process may be initiated by a variety of either hardware or software mechanisms to elect one or more fabric managers for the switched fabric network. A fabric manager is an AS endpoint that “owns” all of the AS devices, including itself, in the network. If multiple fabric managers, e.g., a primary fabric manager and a secondary fabric manager, are elected, then each fabric manager may own a subset of the AS devices in the network. Alternatively, the secondary fabric manager may declare ownership of the AS devices in the network upon a failure of the primary fabric manager, e.g., resulting from a fabric redundancy and fail-over mechanism.

Once a fabric manager declares ownership, it has privileged access to it's AS devices' AS native capability structures. In other words, the fabric manager has read and write access to the AS native capability structures of all of the AS devices in the network, while the other AS devices are restricted to read-only access, unless granted write permission by the fabric manager.

According to the PCI Express Link Layer definition a link is either down (DL_Inactive=no transmission or reception of packets of any type), fully active (DL_Active), i.e., fully operational and capable of transmitting and receiving packets of any type or in the process of being initialized (DL_Init).

AS architecture adds to PCI Express' definition of this state machine by introducing a new data-link layer state, DL_Protected, which becomes an intermediate state between the DL_Init and DL_Active states. The PCI Express DL_Inactive, DL_Init, and DL_Active states are preserved. The new state may be needed to an intermediate degree of communication capability and serves to enhance an AS fabric's robustness and HA (High Availability) readiness.

Link states may be communicated between link partners via DLLPs (Data Link Layer Packets), which are 6-byte packets that communicate link management specific information between the two devices sharing the link. Link state DLLPs have strict priority over all packets (TLPs and DLLPs) except packets that are in-flight. Link state acknowledgements must be sent as early as possible, i.e., as soon as the transmission of the packet currently occupying the link is completed.

The AS architecture supports the establishment of direct endpoint-to-endpoint logical paths known as Virtual Channels (VCs). This enables a single switched fabric network to service multiple, independent logical interconnects simultaneously, each VC interconnecting AS end nodes for control, management, and data. Each VC provides its own queue so that blocking in one VC does not cause blocking in another. Since each VC has independent packet ordering requirements, each VC may be scheduled without dependencies on the other VCs.

The AS architecture defines three VC types: Bypass Capable Unicast (BVC); Ordered-Only Unicast (OVC); and Multicast (MVC). BVCs have two queues—an ordered queue and a bypass queue. The bypass queue provides BVCs bypass capability, which may be necessary for deadlock free tunneling of protocols. OVCs are single queue unicast VCs, which may be suitable for message oriented “push” traffic. MVCs are single queue VCs for multicast “push” traffic.

When the fabric is powered up, link partners in the fabric may negotiate the largest common number of VCs of each VC type. During link training, the largest common sets of VCs of each VC type are initialized and activated prior to any non-DLLP AS packets being injected into the fabric.

During link training, surplus BVCs may be transformed into OVCs. A BVC can operate as an OVC by not utilizing its bypass capability, e.g., its bypass queue and associate logic. For example, if link partner A supports three BVCs and one OVC and the link partner B supports one BVC and two OVCs, the agreed upon number of VCs would one BVC and two OVCs, with one of link partner A's BVCs being transformed into an OVC.

The AS architecture provides a number of congestion management techniques, one of which is a credit-based flow control (FC) technique used to prevent packets from being lost due to congestion. Link partners (e.g., an endpoint 104 and a switch element 102) in the network exchange FC credit information, e.g., the local device's available buffer space for a particular VC, to guarantee that the receiving end of a link has the capacity to accept packets.

FC credits may be computed on a VC-basis by the receiving end of the link and communicated to the transmitting end of the link. Typically, packets may be transmitted only when there are enough credits available for a particular VC to carry the packet. Upon sending a packet, the transmitting end of the link may debit its available credit account by an amount of FC credits that reflects the size of the sent packet. As the receiving end of the link processes (e.g., forwards to an endpoint 104) the received packet, space is made available on the corresponding VC and FC credits are returned to the transmission end of the link. The transmission end of the link then adds the FC credits to its credit account.

FC credit initialization and updates are communicated through the exchange of DLLPs between link partners. InitFC1 and InitFC2 DLLPs are exchanged between link partners and provide the FC credit initialization of both unicast VCs (VCs 0-15) and multicast VCs (VCs 16-19). InitFC1 and InitFC2 DLLPs specifying a VC Index in the range of VC0-VC7 provide initial flow control credit information for any supported BVCS, providing initial values for the bypass queue and the ordered queue. OVC and MVC InitFC DLLPs (VC Indexes in the range of VC8-VC13) provide initial credit information for two VCs each.

VCs may be initialized beginning with VC number 0 and continuing until VC 19 in ascending order. According to the AS Specification, AS ports must exchange InitFC1 and InitFC2 DLLPs for VC 0-19 even if they do not implement all twenty VCs. InitFC DLLPs for unsupported VC numbers must indicate credit values of 000h in their corresponding credit fields.

After initialization, AS ports may refresh their link partner's credit information by periodically sending them FC credit update information. While FC credit accounting is typically tracked by a transmitting port between FC credit updates, an FC Update DLLP takes precedence over locally calculated credit availability information. With each FC credit update, the receiving side of the FC credit update may discard any local FC credit availability tracking information and resynchronize with the credit information provided by the FC Update DLLP.

DLLP transmission may be unreliable, making DLLPs subject to silent loss or corruption. According to the AS Specification, all AS ports are required to maintain a periodic FC credit update “refresh loop” such that each active VC's FC credit is advertised by FC credit update DLLP at intervals no greater than 215 8b/10b symbol times. If the maximum credit refresh interval is exceeded for a given VC, the credit advertising port must, for this case only, elevate the FC Update DLLP to highest priority so that the FC Update DLLP for the subject VC is transmitted at the earliest opportunity.

In an embodiment, a generic state machine may be used to handle FC credit initialization and updates for all three types of VCs, i.e., BVCs, OVCs, and MVCs, while handling each type of VC according to its unique requirements. FIG. 5 illustrates a local AS device 500 including FC state machines 502 for supported VCs. The local device may use the same FC state machines instantiated a number of times to accommodate all supported and potentially supported VC Indexes, where supported VC Indexes include those corresponding to architecturally supported VCs and potentially supported VC Indexes includes VC Indexes corresponding to OVCs that may be re-enabled if BVCs are downgraded during negotiation. VC logic 504 may include the VC queues and generate FC credit values for the VC queues. An arbiter 506 may select which FC DLLPs to forward to the switch fabric 508, e.g., in a round-robin fashion. The arbiter may also be used during discovery to determine which VCs are supported for the particular local device and which are enabled or disable after negotiation with the link partner, including which OVCs are re-enabled in the case of BVCs being downgraded during negotiation.

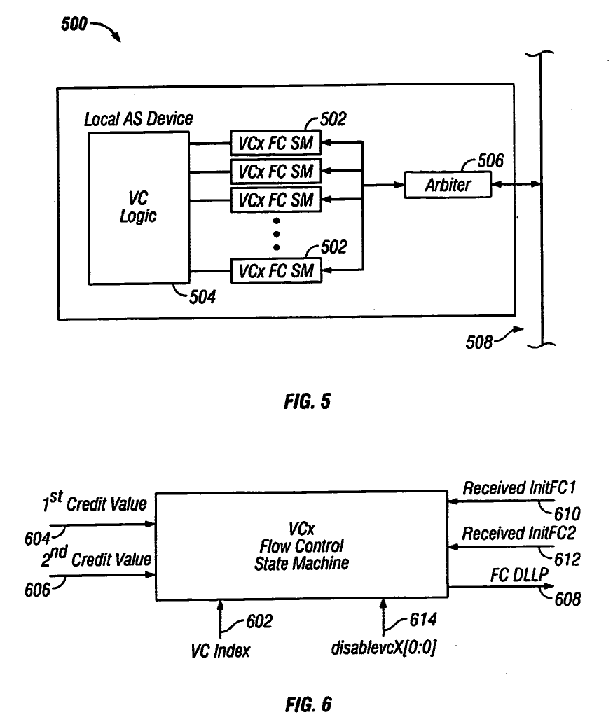

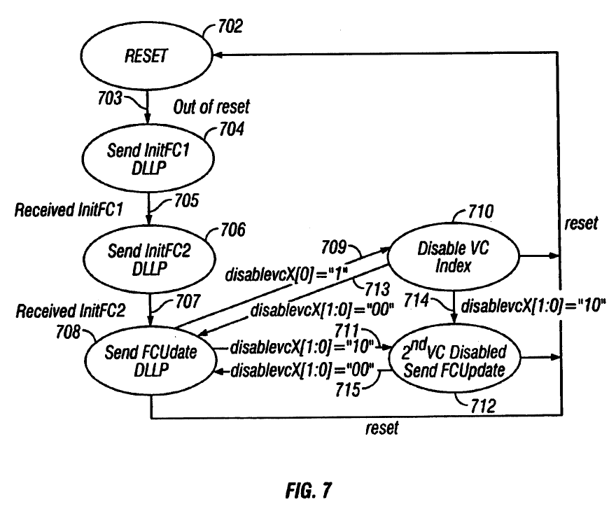

FIG. 6 is a more detailed diagram of the signals received and transmitted by the FC state machine. The FC state machine may receive a hardwired signal “VC Index” which identifies with which VC Index the state machine is associated. The FC state machine may receive first and second credit values 604, 606 for the associated VC Index from the VC logic. The FC state machine may use these credit values to generate InitFC and FC Update DLLPs (collectively “FC DLLPs” 608) for transmission to the arbiter. The arbiter may arbitrate between packets received from the various active VCs and also provide a number of signals to the FC state machine including a notification of having received InitFC1 or InitFC2 DLLPs from the link partner (e.g., “Received InitFC1” 610 and “Received InitFC2” 612) and a status signal “disablevcX[1:0]” 614, which may be used for enabling and disabling the VC Index with which the FC state machine is associated. The arbiter may alter the disable signal 614 in two phases: (1) after initialization and negotiation with the link partner to determine whether the architecturally supported VC(s) for the associated VC Index are active or inactive; and (2) after downgrading of any of the local device's BVCs.

FIG. 7 is a state transition diagram for the FC state machine. After start-up, the state machine may exit state 702 (“RESET”) and transition 703 to state 704 (“Send InitFC1 DLLP”). In state 704, the state machine may use the two credit values from the VC logic to generate an InitFC1 DLLP and transmit the DLLP to the arbiter. When the state machine receives a notification (“Received InitFC1”) that an InitFC1 DLLP for the associated VC Index from the link partner (via the arbiter), the state machine may transition 705 to state 706 (“Send InitFC2 DLLP”). In state 706, the state machine may use the same two credit values that were provided by the VC logic to generate an InitFC2 DLLP and transmit the DLLP to the arbiter. When the state machine receives a notification (“Received InitFC2”) that an InitFC2 DLLP for the associated VC Index from link partner (via the arbiter), the state machine may transition 707 to state 708 (“Send FCUpdate DLLP”).

During discovery and initialization of all VCs, the arbiter may determine which VCs are enabled and disabled.

If the VC Index of the state machine corresponds to a BVC, the arbiter may either send disablevcX[1:0]=“00” signal if the BVC is enabled (where “0” indicates enabled and “1” indicates disabled”, or send a disablevcX[1:0]=“11” signal to indicate that the BVC is disabled, in which case the state machine may transition 709 to state 710 (“Disable VC Index”).

If the VC Index of the state machine corresponds to a pair of MVCs, the arbiter may send a disablevcX[1:0]=“00” signal if both MVCs are enabled, a disablevcX[1:0]=“11” signal if both MVCs are disabled, in which case the state machine may transition 709 to state 710 (“Disable VC Index”), or a disablevcX[1:0]=“10” if one of the MVCs is disabled, in which case the state machine may transition 711 to state 712 (“2^{nd} VC Disabled Send FCUpdate”).

For VC indexes corresponding to BVCs, MVCs, and OVCs, the state machine only needs to inspect the zero^{th} position, i.e., disablevcX[0], to determine if the entire VC Index is disabled because if one of the VCs corresponding to that VC Index is enabled, its credit value will be in the zero^{th} position in the FC DLLP.

If the VC Index of the state machine corresponds to a pair of OVCs, the arbiter may send a disablevcX[1:0]=“00” signal if both OVCs are enabled, a disablevcX[1:0]=“11” signal if both OVCs are disabled, in which case the state machine may transition 709 to state 710 (“Disable VC Index”), or a disablevcX[1:0]=“10” if one of the MVCs is disabled, in which case the state machine may transition 711 to state 712 (“2^{nd} VC Disabled Send FCUpdate”).

If any BVCs are downgraded after initialization, the arbiter may transmit a disablevcX[1:0]=“00” to the state machine if two of the OVCs corresponding to VC Index are re-enabled or a disablevcX[1:0]=“10” if one of the OVCs corresponding to VC Index is re-enabled. If the state machine is in state 710 (“Disable VC Index”), the state machine may transition 713 to state 708 (“Send FCUpdate DLLP”) in response to a disablevcX[1:0]=“00” signal and may transition 714 to state 712 (“2^{nd} VC Disabled Send FCUpdate”) in response to a disablevcX[1:0]=“10” signal. If the state machine is in state 712 (“2^{nd} VC Disabled Send FCUpdate”), the state machine may transition to state 708 (“Send FCUpdate DLLP”) in response to a disablevcX[1:0]=“00” signal.

After initialization and negotiation, including any downgrading of BVCs to OVCs, the state machine may remain in the last state (e.g., state 708, 710, or 712) until reset, at which point it may return to state 702. If the state machine is in state 708 (“Send FCUpdate DLLP”), the state machine may transmit periodic FC credit update DLLPs with two credit values to the link partner. If the state machine is in state 710 (“Disable VC Index”), the VC Index is disabled, and the state machine may not send any FC Update DLLPs. If the state machine is in state 712 (“2^{nd} VC Disabled Send FCUpdate DLLP”), the state machine may transmit periodic FC Update DLLPs, with the credit value in the DLLP for the second OVC or MVC being set to a null value.

A number of embodiments have been described. Nevertheless, it will be understood that various modifications may be made without departing from the spirit and scope of the invention. For example, the status signal disablevcX[1:0] may have different values associated with different state transitions. Accordingly, other embodiments are within the scope of the following claims.

1. A method comprising:
performing an initialization and discovery operation in an Advanced Switching (AS) device; and
utilizing a generic state machine to enable or disable virtual channel (VC) indexes in a plurality of VC index corresponding to bypass capable VCs (BVCs), ordered only VCs (OVCs), and multicast VCs (MVCs).

2. The method of claim 1, wherein said utilizing the generic state machine comprises:
traversing a plurality of states in the state machine in response to a plurality of signals including a disable signal, the plurality of states including a disabled state, an enabled state, and a partially enabled state.

3. The method of claim 2, further comprising:
generating a flow control (FC) update packet in the enabled state.

4. The method of claim 2, further comprising:
generating an FC update packet including FC update data for one active VC in the partially enabled state.

5. The method of claim 2, further comprising:
transitioning from a reset state to one or more initialization states in the state machine; and
transitioning from the one or more initialization states to the enabled state in response to one or more initialization requirements being satisfied.

6. The method of claim 5, further comprising:
for a VC index corresponding to a BVC, transitioning to the disabled state in response to receiving a disable signal indicating said VC index is disabled.

7. The method of claim 5, further comprising:
for a VC index corresponding to two MVCs, in response to receiving a disable signal indicating, both MVCs are disabled, transitioning to the disabled state; and
in response to receiving a disable signal indicating one MVC is disabled, transitioning to the partially enabled state.

8. The method of claim 5, further comprising:
for a VC index corresponding to two OVCs,
in response to receiving a disable signal indicating both OVCs are disabled, transitioning to the disabled state; and
in response to receiving a disable signal indicating one OVC is disabled, transitioning to the partially enabled state.

9. The method of claim 8, further comprising:
in the disabled state, transitioning to the partially enabled state in response to a disable signal indicating one disabled OVC corresponding to the VC index has been re-enabled.

10. The method of claim 8, further comprising:
in the disabled state, transitioning to the enabled state in response to a disable signal indicating both disabled OVCs corresponding to the VC index have been re-enabled.

11. The method of claim 8, further comprising:
in the partially enabled state, transitioning to the enabled state in response to a disable signal indicating one disabled OVC has been re-enabled.

12. An apparatus comprising:
virtual channel (VC) logic to provide flow control (VC) data for a plurality of VCs including bypass capable VCs (BVCs), ordered only VCs (OVCs), and multicast VCs (MVCs), each VC corresponding to one of a plurality of VC indexes;
an arbiter to arbitrate packets to and from the plurality of VCs and to generate a disable signal for enabling and disabling VCs; and
a generic state machine for each of the plurality of VC indexes, the generic state machine for each VC index including the same states and state transitions.

13. The apparatus of claim 12, wherein the generic state machine comprises:
a plurality of states including a disabled state, an enabled state, and a partially enabled state, wherein the state machine is operative to transition between states in response to a plurality of signals including the disable signal.

14. The apparatus of claim 13, wherein the state machine is operative to generate a flow control (FC) update packet in the enabled state.

15. The apparatus of claim 13, wherein the state machine is operative to generate an FC update packet including FC update data for one active VC in the partially enabled state.

16. The apparatus of claim 13, wherein the state machine is operative to:
transition from a reset state to one or more initialization states in the state machine; and
transition from the one or more initialization states to the enabled state in response to one or more initialization requirements being satisfied.

17. The apparatus of claim 16, wherein the state machine is operative to:
for a VC index corresponding to a BVC, transition to the disabled state in response to receiving a disable signal indicating said VC index is disabled.

18. The apparatus of claim 16, wherein the state machine is operative to:
for a VC index corresponding to two MVCs,
transition to the disabled state in response to receiving a disable signal indicating both MVCs are disabled; and
transition to the partially enabled state in response to receiving a disable signal indicating one MVC is disabled.

19. The apparatus of claim 16, wherein the state machine is operative to:
for a VC index corresponding to two OVCs,
transition to the disabled state in response to receiving a disable signal indicating both OVCs are disabled; and
transition to the partially enabled state in response to receiving a disable signal indicating one OVC is disabled.

20. The apparatus of claim 19, wherein the state machine is operative to:
in the disabled state, transition to the partially enabled state in response to a disable signal indicating one disabled OVC corresponding to the VC index has been re-enabled.

21. The apparatus of claim 19, wherein the state machine is operative to:
in the disabled state, transition to the enabled state in response to a disable signal indicating both disabled OVCs corresponding to the VC index have been re-enabled.

22. The apparatus of claim 19, wherein the state machine is operative to:
in the partially enabled state, transition to the enabled state in response to a disable signal indicating one disabled OVC has been re-enabled.

23. An article comprising a machine-readable medium including machine-executable instructions to cause a machine to:
perform an initialization and discovery operation in an Advanced Switching (AS) device; and
utilize a generic state machine to enable or disable virtual channel (VC) indexes in a plurality of VC index corresponding to bypass capable VCs (BVCs), ordered only VCs (OVCs), and multicast VCs (MVCs).

24. The article of claim 23, wherein the generic state machine comprises:
a plurality of states including a disabled state, an enabled state, and a partially enabled state, wherein the state machine is operative to transition between states in response to a plurality of signals including the disable signal.
